(19) United States
(12) Patent Application Publication
(10) Pub. No.: US 2022/0388377 A1
(43) Pub. Date: Dec. 8, 2022

(54) CONTROL DEVICE

(71) Applicant: KABUSHIKI KAISHA TOKAI RIKA DENKI SEISAKUSHO, Aichi (JP)

(72) Inventor: Toshihiro TANAKA, Aichi (JP)

(21) Appl. No.: 17/767,004

(22) PCT Filed: Sep. 16, 2020
(86) PCT No.: PCT/JP2020/035024

§ 371 Date: Apr. 6, 2022

(30) Foreign Application Priority Data
Oct. 9, 2019 (JP) 2019-185818

(51) Int. Cl. B60J 1/17; E05F 17/00; H01H 23/02; E05F 15/689

(52) U.S. Cl. CPC B60J 1/17; E05F 17/00; H01H 23/02; E05F 15/689; E05Y 2400/854; E05Y 2900/55

(57) ABSTRACT

A control device includes one operation knob which includes operation regions set so as to correspond to plural windows of a vehicle and on which a push-down operation and a pull-up operation can be performed, a contact detection unit to detect contact of a user with plural operation regions, an operation detection unit to detect the push-down operation and the pull-up operation performed on the operation knob, and a control unit that is configured, based on a predetermined operation performed on at least one of the plural operation regions and also based on the push-down operation or the pull-up operation performed on the operation knob, to determine plural windows to be opened or closed and control a power window device to drive the plural determined windows.

### CROSS-REFERENCES TO RELATED APPLICATIONS

The present patent application claims the priority of Japanese patent application No. 2019/185818 filed on Oct. 9, 2019, and the entire contents of Japanese patent application No. 2019/185818 are hereby incorporated by reference.

### Technical Field

The present invention relates to a control device.

### BACKGROUND ART

A power window device is known which includes drive means respectively moving plural window glasses of a vehicle, an operation means to drive the drive means, and a control means that controls the drive means to move the window glasses to open or close according to an operation performed on the operation means (see, e.g., Patent Literature 1).

The operation means of this power window device includes plural window switches corresponding to the plural window glasses. Then, when a special operation, which is an operation different from a normal operation of individually operating the plural window switches, is performed, the control means controls the drive means to move all window glasses so that these window glasses are moved at different movement timings.

### CITATION LIST

### Patent Literature

Patent Literature 1: JP 2016/124329 A

### SUMMARY OF INVENTION

### Technical Problem

If, e.g., the power window device disclosed in Patent Literature 1 is configured to have a single switch instead of the plural window switches and include operation regions set on a knob so as to correspond to the window glasses and is configured such that window glasses corresponding operation regions touched by a user during operation are opened or closed, it is necessary to perform the operation while touching plural operation regions to open or close plural window glasses, hence, poor operability.

It is an object of the invention to provide a control device with excellent operability.

### Solution to Problem

A control device in an embodiment of the invention comprises a control unit that is configured, based on a predetermined operation performed on at least one operation region among operation regions set on one operation knob so as to correspond to a plurality of windows of a vehicle and also based on a push-down operation or a pull-up operation performed on the operation knob, to determine a plurality of windows to be opened or closed and control a power window device to drive the plurality of determined windows.

### Advantageous Effects of Invention

According to an embodiment of the invention, a control device with excellent operability can be provided.

### BRIEF DESCRIPTION OF DRAWINGS

FIG. 1A is a top view showing a control device in the first embodiment.

FIG. 1B is a cross-sectional view when a cross section cut along line I(b)-I(b) of FIG. 1A is viewed in a direction of arrow.

FIG. 2 is a block diagram illustrating the control device in the first embodiment.

FIG. 3A is a top view showing a vehicle on which the control device in the first embodiment is mounted.

FIG. 3B is an explanatory diagram illustrating a door for explaining a position of the control device in the first embodiment.

FIG. 4A is an explanatory diagram for explaining a predetermined operation performed on an operation device in the first embodiment to open or close all windows.

FIG. 4B is an explanatory diagram for explaining timing of the predetermined operation.

FIG. 5 is a flowchart showing an operation of the control device in the first embodiment.

FIG. 6A is an explanatory diagram illustrating plural touch operations performed on the control device in the second embodiment within a second time.

FIG. 6B is an explanatory diagram illustrating a long press operation performed on the control device in the third embodiment for a duration longer than a third time.

### DESCRIPTION OF EMBODIMENTS

### Summary of the Embodiments

A control device in embodiments has a control unit that is configured, based on a predetermined operation performed on at least one operation region among operation regions set on one operation knob so as to correspond to a plurality of windows of a vehicle and also based on a push-down operation or a pull-up operation performed on the operation knob, to determine a plurality of windows to be opened or closed and control a power window device to drive the plurality of determined windows.

The control device allows a user to open or close plural windows by performing a predetermined operation on at least one of the operation regions at the time of opening or closing the plural windows. Therefore, it is excellent in operability as compared to when such a configuration is not adopted.

### First Embodiment

### General Configuration of a Control Device 1

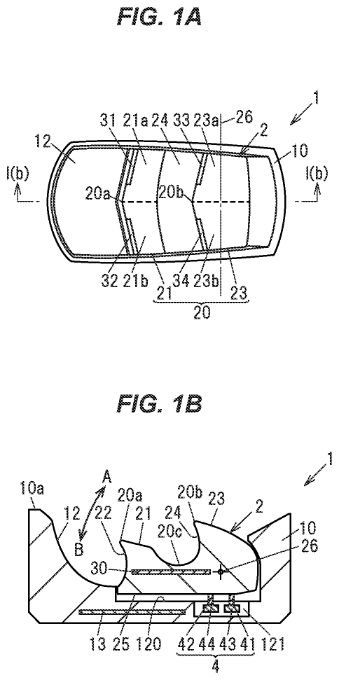

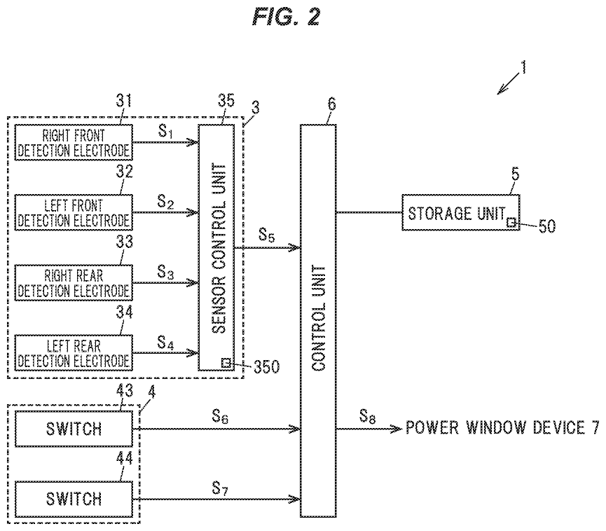

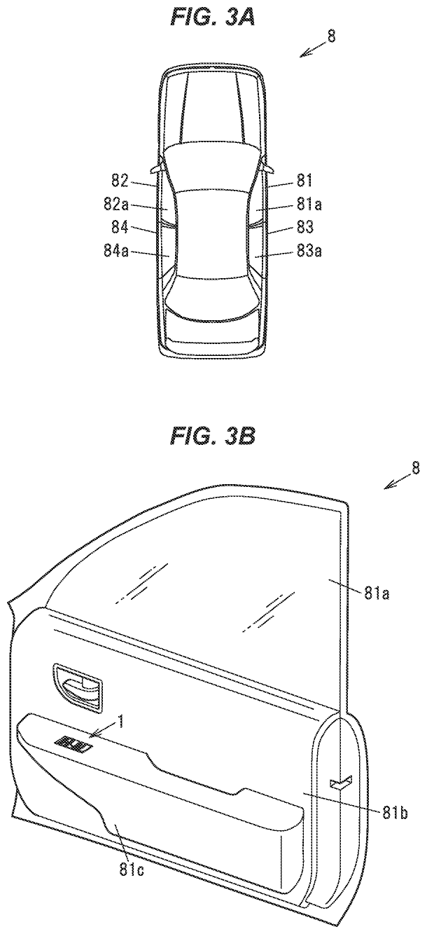

FIG. 1A is a top view showing a control device, and FIG. 1B is a cross-sectional view when a cross section cut along line I(b)-I(b) of FIG. 1A is viewed in a direction of arrow. FIG. 2 is a block diagram illustrating the control device. FIG. 3A is a top view showing a vehicle on which the control device is mounted, and FIG. 3B is an explanatory diagram illustrating a door for explaining a position of the control device. In each drawing of the embodiments described below; a scale ratio may be different from an actual ratio. In addition, in FIG. 2A, flows of main signals and information are indicated by arrows.

A control unit 1 in the first embodiment is configured such that a predetermined operation is set to open or close plural windows by a simple operation, and selected plural windows are opened or closed based on detection of the predetermined operation.

In particular, as shown in FIGS. 1A to 2, the control device 1 includes one operation knob 2 which has operation regions set so as to correspond to plural windows of a vehicle and on which a push-down operation and a pull-up operation can be performed, a contact detection unit 3 to detect contact of a user with the plural operation regions, an operation detection unit 4 to detect the push-down operation and the pull-up operation performed on the operation knob 2, and a control unit 6 that is configured, based on a predetermined operation performed on at least one of the plural operation regions and also based on a push-down operation or a pull-up operation performed on the operation knob 2, to determine plural windows to be opened or closed and control a power window device 7 to drive the determined plural windows.

The predetermined operation consists of touch operations performed on plural operation regions within a predetermined first time T₁. The control unit 6 controls the power window device 7 to drive windows corresponding to the plural operation regions in which the touch operation is detected. The first time T₁ is preferably set within a range of more than 0 s and not more than 1 s, and is more preferably set within a range of more than 0 and not more than 0.5 s, as an example.

The touch operation is an operation performed by a user by touching the operation region with an operation finger. In the following description, the touch operation is an operation including a tap operation performed by touching the operation region with an operation finger for a short time and then lifting the finger.

As an example, the control device 1 is arranged in a right-hand drive four-door vehicle 8, as shown in FIGS. 3A and 3B. In more particular, the control device 1 is arranged on an armrest 81c attached to a door trim 81b of a driver's side door 81 of the vehicle 8, as shown in FIG. 3B.

The control device 1 is configured be capable of instructing the power window device 7 to open and close windows 81a to 84a on doors 81 to 84. That is, the plural windows mentioned above are the windows 81a to 84a. The control device 1 may be arranged on a. door other than the driver's side or may be arranged in a two-door vehicle.

A groove 24 is formed on a surface 20 of the operation knob 2, and the operation knob 2 is divided at the groove 24 into a front-end operation region 21 corresponding to the front seat windows 81a, 82a and a rear-end operation region 23 corresponding to the rear seat windows 83a, 84a.

The front-end operation region 21 has a first operation region 21a corresponding to the driver's seat window 81a and a second operation region 21b corresponding to the front passenger seat window 82a. The rear-end operation region 23 has a third operation region 23a corresponding to the window 83a behind the driver's seat and a fourth operation region 23b corresponding to the window 84a behind the front passenger seat. That is, the operation regions mentioned above are the first to fourth operation regions 21a-23b.

### Configuration of the Operation Knob 2

The operation knob 2 is formed of a resin material. The operation knob 2 is arranged in a recessed portion 12 of a main body 10, as shown in FIG. 1B. The recessed portion 12 has a curved surface so that the operation finger of the user is guided downward from an upper surface 10a of the main body 10. The operation knob 2 is attached to the main body 10 so as to rotate inside the recessed portion 12 in an arrow A direction and an arrow B direction about a shaft 26. The arrow A direction is a direction in which the operation knob 2 is pulled up. The arrow B direction is a direction in which the operation knob 2 is pushed down.

As shown in FIG. 1A, the groove 24 of the operation knob 2 when viewed from above is formed to have a curved shape rather than a linear shape, In addition, as shown in FIG. 1B, the groove 24 when viewed in a cross section cut along line I(b) I(b) is curved from a rear end of the front-end operation region 21 to a vertex 20b of the rear-end operation region 23. The shape of the groove 24 from the vertex 20b to a lower surface 20c allows the user to easily perform a pull-up operation by hooking the operation finger.

The operation knob 2 also has a side surface 22 having a shape curved from a vertex 20a on the front side toward a lower surface 25 of the operation knob 2. The side surface 22 has a shape which is recessed toward the inside of the operation knob 2, from the vertex 20a toward the rear end. The shape of the side surface 22 also allows the user to easily perform a pull-up operation by hooking the operation finger, in the same manner as the groove 24.

The first operation region 21a is a region on the upper side of a dotted line drawn at the center of the front-end operation region 21 in FIG. 1A and further includes a region of the side surface 22 on the right side of the vertex 20a. The second operation region 21b is a region on the lower side of the dotted line drawn at the center of the front-end operation region 21 in FIG. 1A and further includes a region of the side surface 22 on the left side of the vertex 20a. That is, the first operation region 21a and the second operation region 21b are regions serving as two knobs respectively corresponding to the front seat windows 81a, 82a, and are regions which are touched at the time of a push-down operation and a pull-up operation on the respective knobs.

The third operation region 23a is a region on the upper side of a dotted line drawn at the center of the rear-end operation region 23 in FIG. 1A and further includes a region up to the lower surface 20c of the groove 24 on the right side of the vertex 20b. The fourth operation region 23b is a region on the lower side of the dotted line drawn at the center of the rear-end operation region 23 in FIG. 1A and further includes a region up to the lower surface 20c of the groove 24 on the left side of the vertex 20b. That is, the third operation region 23a and the fourth operation region 23b are regions serving as two knobs respectively corresponding to the rear seat windows 83a, 84a, and are regions which are touched at the time of a push-down operation and a pull-up operation on the respective knobs.

Since the operation knob 2 has the first to fourth operation regions 21a-23b as described above, the four windows 81a-84a can be operated by one knob and the size is small.

### Configuration of the Contact Detection Unit 3

The contact detection unit 3 in the first embodiment is an electrostatic capacitance touch sensor that detects proximity or contact of a detection target to/with the first to fourth operation regions 21a-23b of the operation knob 2.

In particular, as shown in FIG. 2, the contact detection unit 3 has a right front detection electrode 31 to a left rear detection electrode 34 that are arranged in the first to fourth operation regions 21a to 23b, and a sensor control unit 35 that determines proximity and contact of the detection target based on first to fourth output signals S₁ to S₄ acquired from the right front detection electrode 31 to the left rear detection electrode 34. The sensor control unit 35 is arranged on a sub-substrate 30. The sub-substrate 30 is arranged in the operation knob 2. The detection target is the operation finger of the user.

The right front detection electrode 31 to the left rear detection electrode 34 are formed of a conductive metal material. The right front detection electrode 31 to the left rear detection electrode 34 are arranged on the operation knob 2 at a boundary between the surface 20 and the side surface 22 and a boundary between the surface 20 and the groove 24, i.e., at the comers on both sides of the vertex 20a and the vertex 20b. In addition, the right front detection electrode 31 to the left rear detection electrode 34 are exposed on the surface 20, the side surface 22 and the groove 24 to detect contact with the surface 20 as well as contact with the side surface 22 and the groove 24.

The right front detection electrode 31 to the left rear detection electrode 34 have a long shape as shown in FIG. 1A, but it is not limited thereto as long as it is a shape capable of detecting proximity and contact of the operation finger to/with the first to fourth operation regions 21a to 23b. The right front detection electrode 31 to the left rear detection electrode 34 are also decorative components to decorate the operation knob 2.

The sensor control unit 35 is a microcomputer composed of a CPU (=Central Processing Unit) performing calculation and processing, etc., of the acquired data according to a stored program, and a RAM (=Random Access Memory) and a ROM (=Read Only Memory) as semiconductor memories, etc. The ROM stores a program for operation of the sensor control unit 35. The RAM, is used as a storage area to temporarily store calculation results, etc. The sensor control unit 35 also has, inside thereof, a means to generate a clock signal and operates based on the clock signal. This clock signal is synchronized with the control unit 6.

The sensor control unit 35 is, e.g., an electrostatic capacitance sensor IC (=Integrated Circuit). The contact detection unit 3 is configured as a self-capacitance type touch sensor in which capacitance increases when the operation finger of the user comes in proximity or contact with the right front detection electrode 31 to the left rear detection electrode 34. The sensor control unit 35 has a capacitance threshold value 350 in the RAM or the ROM and determines that there is proximity or contact of the operation finger of the user when capacitance of not less than the capacitance threshold value 350 is detected. In this regard, the contact detection unit 3 is not limited to the self-capacitance type touch sensor and may be a mutual-capacitance type touch sensor or another type of touch sensor.

The first to fourth output signals S₁ to S₄ acquired by the sensor control unit 35 from the right front detection electrode 31 to the left rear detection electrode 34 are analog signals. The sensor control unit 35 determines whether or not there is proximity or contact for each of the right front detection electrode 31 to the left rear detection electrode 34, and outputs the result as a detection signal S₅ to the electrically connected control unit 6, The detection signal S₅ is a digital signal. The sensor control unit 35 is connected to the control unit 6 by a flexible cable.

The sensor control unit 35 is mounted on the sub-substrate 30 (shown in FIG. 1B) which is arranged in the operation knob 2. The sub-substrate 30 is a printed circuit board on which wiring and electrode pads, etc., are provided. The right front detection electrode 31 to the left rear detection electrode 34 are electrically connected to the sensor control unit 35 via the electrode pads or wiring formed on the sub-substrate 30.

Since the contact detection unit 3 is arranged on the operation knob 2 and sends the detection result to the main body 10 side using digital signals instead of analog signals, it is less likely to be affected by external noise as compared to when sending analog signals. As a result, the control device 1 has high accuracy in detecting the operation finger of the user.

The contact detection unit 3 is not limited to the touch sensor and may be a pressure sensor, etc., that detects contact with the operation knob 2, as a modification.

### Configuration of the Operation Detection Unit 4

As shown in FIG. 1B, the operation detection unit 4 has a rod 41, a rod 42, a switch 43 and a switch 44. The rod 41 and the rod 42 are in contact with protrusions provided inside the operation knob 2 and are also in contact with the switch 43 and the switch 44. The switch 43 and the switch 44 are configured to be turned into a first ON state and a second ON state via the rod 41 and the rod 42 by a pull-up operation and a push-down operation performed on the operation knob 2.

Each of the switch 43 and the switch 44 is composed of two switches, as an example. As shown in FIG. 1B, the switch 43 and the switch 44 are arranged in an arrangement recess 121 provided on a bottom surface 120 of the recessed portion 12 of the main body 10.

When the operation knob 2 is pulled up, a first switch of the switch 43 is firstly turned into the ON state (the first ON state). When the operation knob 2 is further pulled up, the first switch and a second switch of the switch 43 are turned into the ON state (the second ON state). Likewise, when the operation knob 2 is pushed down, a first switch of the switch 44 is firstly turned into the ON state (the first ON state). When the operation knob 2 is further pushed down, the first switch and a second switch of the switch 44 are turned into the ON state (the second ON state).

A mode when the operation knob 2 is pulled up and the switch 43 is turned to the first ON state is a manual mode in which the window is driven in a closing direction. A mode when the operation knob 2 is further pulled up and the switch 43 is turned to the second ON state is an automatic mode in which the window is driven until fully closed.

A mode when the operation knob 2 is pushed down and the switch 44 is turned to the first ON state is the manual mode in which the window is driven in an opening direction. A mode when the operation knob 2 is further pushed down and the switch 44 is turned to the second ON state is the automatic mode in which the window is driven until fully opened.

The operation detection unit 4, when detected pulling-up of the operation knob 2, outputs a switch signal S₆ corresponding to the ON state from the switch 43 to the electrically connected control unit 6. Meanwhile, the operation detection unit 4, when detected pushing-down of the operation knob 2, outputs a switch signal S₇ corresponding to the ON state from the switch 44 to the electrically connected control unit 6.

### Configuration of a Storage Unit 5

A storage unit 5 is electrically connected to the control unit 6. The storage unit 5 may be an external storage device connected outside the control unit 6, or may be a RAM of the control unit 6 or a semiconductor memory provided on a main substrate 13. Condition information 50 (described later) is stored in the storage unit 5.

### Configuration of the Control Unit 6

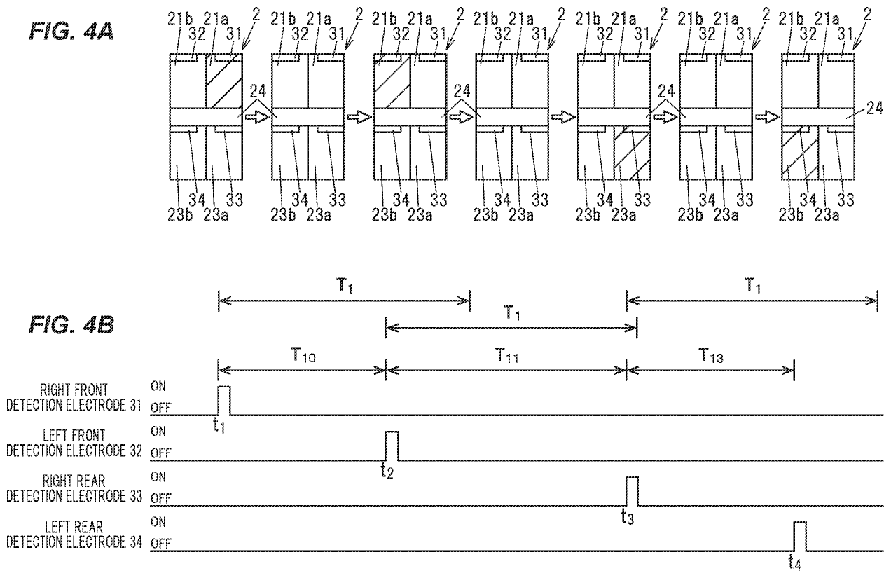

FIG. 4A is an explanatory diagram for explaining a predetermined operation to open or close all windows. FIG. 4B is an explanatory diagram for explaining timing of the predetermined operation. In FIG. 4B, the horizontal axis is time t. In addition, in FIG. 4B, “ON” indicates that the operating finger is detected by the detection electrode, and “OFF” indicates no detection.

The control unit 6 is a microcomputer composed of a CPU performing calculation and processing, etc., of the acquired data according to a stored program, and a RAM and a ROM as semiconductor memories, etc. The ROM stores a program for operation of the control unit 6. The RAM is used as a storage area to temporarily store calculation results, etc. The control unit 6 also has, inside thereof, a means to generate a clock signal and operates based on the clock signal.

The control unit 6 confirms a window to be driven, based on the operation region in which a touch operation is detected. Then, the control unit 6 increases flag by +1 to correspond to the number of the confirmed windows. This flag corresponds to the number of windows and is thus a number between 0 (=no window confirmed) and 4 (all windows confirmed).

The control unit 6 measures elapsed time since time of detection of the last touch operation, and resets the windows confirmed to be driven and the flag when “ON” of the switches is not detected until the elapsed time exceeds a predetermined prescribed time. That is, the control unit 6 accepts a push-down operation or a pull-up operation performed within the prescribed time since the last touch operation.

As an example, the prescribed time is preferably set within a range of not less than 1 s and not more than 3 s, and is more preferably set within a range of not less than is and not more than 2 s.

Therefore, when opening or closing plural windows simultaneously, the user performs touch operations on the operation regions corresponding to the plural windows to be driven and then performs a push-down operation or a pull-up operation on the operation knob 2 within the prescribed time.

The condition information 50 is information about conditions of time, etc., i.e., information about the prescribed time and the first time T₁. Based on the condition information .50, the control unit 6 determines whether or not the elapsed time between touch operations is within the first time T₁. Next, an operation to open or close all windows will be described.

In FIGS. 4A and 4B, at time t₁, a touch operation is performed on the first operation region 21a such that the right front detection electrode 31 is turned from “OFF” to “ON”, at time t₂, a touch operation is performed on the second operation region 21b such that the left front detection electrode 32 is turned from “OFF” to “ON”, at time t₃, a touch operation is performed on the third operation region 23a such that the right rear detection electrode 33 is turned from “OFF” to “ON”, and at time t₄, a touch operation is performed on the fourth operation region 23b such that the left rear detection electrode 34 is turned from “OFF” to “ON”. Diagonal lines shown in FIG. 4A indicate that the detection electrodes have detected the operation finger.

When a touch operation on the first operation region 21a is detected at the time t₁, the control unit 6 confirms the window 81a corresponding to the first operation region 21a as an object to be driven, sets the flag to 1, and starts to measure elapsed time T₁₀. The flag at this time is 1.

Then, when a touch operation on the second operation region 21b is detected at the time t₂ before the lapse of the first time T₁, the control unit 6 confirms the window 82a corresponding to the second operation region 21b as the object to be driven, increases the flag by +1, stops measuring the elapsed time T₁₀ from the time t₁, and newly starts measurement of elapsed time T₁₁ from the time t₂. The flag at this time is 2.

Here, if the next touch operation is not detected within the first time T₁, the control unit 6 determines that the window 81a is to be driven. When a push-down operation or a pull-out operation is then performed on the operation knob 2 within the prescribed time, the control unit 6 generates operation information S₈ to open or close the window 81a according to the operation and outputs it to the power window device 7. In this regard, the power window device 7 is configured to stop driving without instruction from the control device 1 once the window is fully opened and fully closed.

When a touch operation on the third operation region 23a is detected at the time t₃ before the elapsed time T₁₁ which is being measured from time t₂ exceeds the first time T₁, the control unit 6 confirms the window 83a corresponding to the third operation region 23a as the object to be driven, increases the flag by +1, stops measuring the elapsed time T₁₁ from the time t₂, and newly starts measurement of elapsed time T₁₂ from the time t₃. The flag at this time is 3.

Here, when the next touch operation is not detected within the first time T₁, the control unit 6 determines that the window 81a and the window 82a are to be driven. When a push-down operation or a pull-out operation is then performed on the operation knob 2 within the prescribed time, the control unit 6 generates the operation information S₈ to open or close the window 81a and the window 82a according to the operation and outputs it to the power window device 7.

When a touch operation on the fourth operation region 23b is detected at the time t₄ before the elapsed time T₁₂ which is being measured from time t₃ exceeds the first time T₁, the control unit 6 confirms the window 84a corresponding to the fourth operation region 23b as the object to be driven, increases the flag by +1, and stops measuring the elapsed time T₁₂ from the time t₃. The flag at this time is 4.

Then, based on the operation performed on the operation knob 2 within the prescribed time, the control unit 6 opens or closes the windows 81a to 84a since the first to fourth operation regions 21a to 23b were each operated within the first time T₁, i.e., the flag is 4.

When the switch 43 or the switch 44 is turned from “OFF” to “ON”, i.e., when a push-down operation or a pull-up operation is performed on the operation knob 2, during the measurement of the elapsed time T₁₀, the elapsed time T₁₁ and the elapsed time T₁₂, the control unit 6 generates and outputs the operation information S₈ to open or close the window/windows that has/have been confirmed at that time.

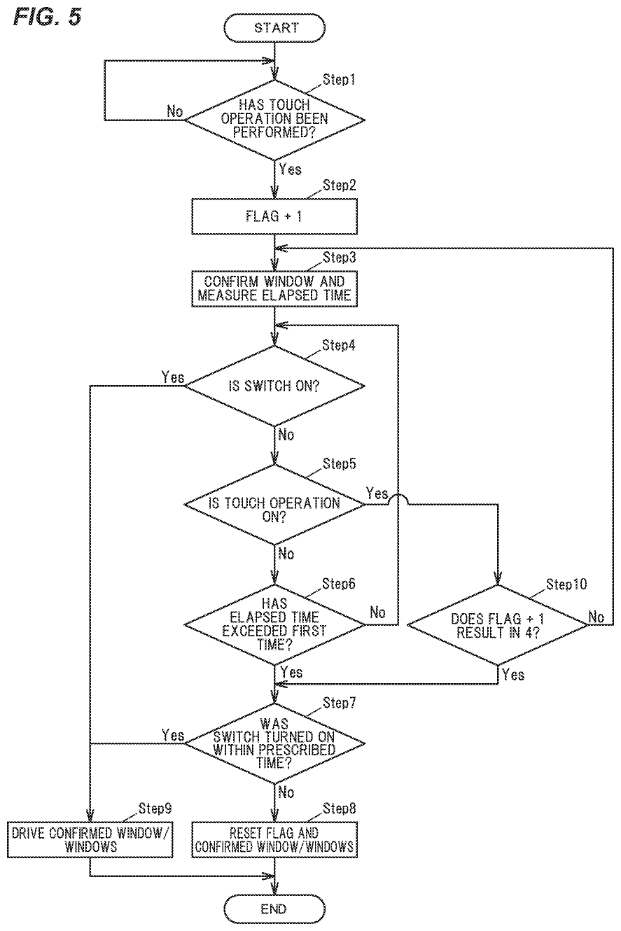

Next, an example operation of the control device 1 in the first embodiment will be described with reference to the flowchart of FIG. 5.

### Operation

When it is “Yes” in Step 1, i.e., when at least one detection electrode is turned “ON” and a touch operation is detected based on the detection signal S₅ acquired from the contact detection unit 3 (Step 1: Yes), the control unit 6 of the control device 1 increases the flag to 1 (Step 2).

The control unit 6 confirms the window corresponding to the detection electrode turned “ON” as the window to be driven, and measures elapsed time from the moment it is turned “ON”.

When all switches are “OFF” based on the switch signal S₆ and the switch signal S₇ acquired from the operation detection unit 4 (Step 4: No), and a touch operation is not detected by the remaining detection electrodes based on the detection signal S₅ acquired from the contact detection unit 3 (Step 5: No), and also the elapsed time which is being measured exceeds the first time T₁ (Step 6: Yes), and furthermore no switch is not turned “ON” within the prescribed time (Step 7: No). the control unit 6 determines that an operation of opening or closing is not performed, resets the flag and the confirmed window, and ends the process (Step 8).

Here, when any of the switches is turned “ON” in Step S4 (Step 4: Yes), the control unit 6 generates the operation information S₈ which instructs to drive the window already confirmed at that time and also indicates the driving direction, and outputs it to the power window device 7 (Step 9). The operation information S₈ is kept output during when the switch is “ON” if it is in the manual mode, and only an instruction to fully open or fully close the window/windows is output if it is in the automatic mode.

Meanwhile, when a touch operation is detected by a remaining detection electrode in Step 5 (Step 5: Yes), the control unit 6 increases the flag by +1. When this results in the flag=4 (Step 10: Yes), the control unit 6 proceeds the process to Step 7.

Meanwhile, when the elapsed time has not reached the first time T₁ in Step 6 (Step 6: No), the control unit 6 proceeds the process to Step 4. The control unit 6 repeats Step 4 to Step 6 until any switch is turned “ON”, or the other detection electrode is turned “ON”, or the elapsed time exceeds the first time T₁, after the touch operation is detected.

Meanwhile, when any of the switches is turned “ON” within the prescribed time in Step 7 (Step 7: Yes), the control unit 6 proceeds the process to Step 9.

Furthermore, when the flag is less than 4 even after increment by +1 in Step 10 (Step 10: No), i.e., when there is an operation region(s) which is not touch-operated, the control unit 6 proceeds the process to Step 3.

### Effects of the First Embodiment

The control device 1 in the first embodiment is excellent in operability. In particular, when the user wants to open or close plural windows simultaneously, desired windows can be simultaneously opened or closed by performing touch operations on the operation regions corresponding to such plural windows and then performing a push-down operation or a pull-up operation, hence, the control device 1 is excellent in operability as compared to when such a configuration is not adopted.

When time between a touch operation and another touch operation at the time of selecting windows to be opened or closed is within the first time T₁, the control device 1 accepts the operation. Therefore, it is possible to suppress opening or closing of an unintended window as compared to when such a configuration is not adopted,

The control device 1 can instruct to open or close the windows 81a to 84a by one operation knob 2. Therefore, it is easy to reduce the size and operability is excellent as compared to when four operation knobs are provided.

### Second Embodiment

The second embodiment is different from the other embodiments in that all windows are opened or closed by plural touch operations performed in any operation region.

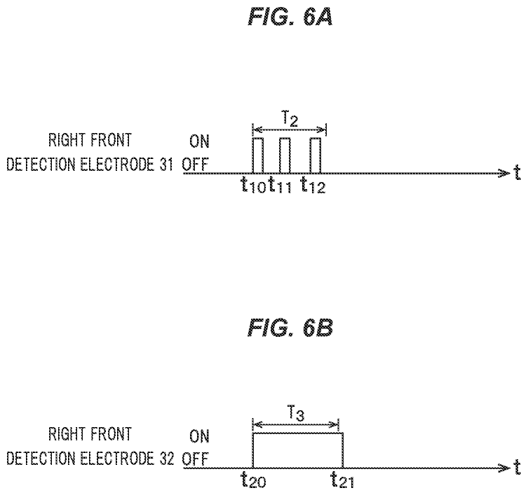

FIG. 6A is an explanatory diagram illustrating plural touch operations performed within a second time. In FIG. 6A, the horizontal axis is time t. In addition, in FIG. 6A, “ON” indicates that the operating finger is detected by the detection electrode, and “OFF” indicates no detection. FIG, 6A and FIG. 6B (described later) show a case where the right front detection electrode 31 is touch-operated, as an example. In the embodiments described below, portions having the same functions and configurations as those in the first embodiment are denoted by the same reference signs as those in the first embodiment, and the description thereof will be omitted.

The predetermined operation of the second embodiment consists of plural touch operations performed on any operation region within a predetermined second time T₂. When plural touch operations are detected in any of the operation regions, the control unit 6 controls the power window device 7 to drive all windows according to a push-down operation or a pull-up operation performed on the operation knob 2.

The predetermined operation of the second embodiment consists of three touch operations, as an example. Therefore, the condition information 50 in the second embodiment includes information about three touch operations within the second time T₂. That is, as shown in FIG. 6A, when it is determined, based on the condition information 50, that three consecutive touch operations are detected in any operation region within the second time T₂, the control unit 6 opens or closes all the windows according to a push-down operation or a pull-up operation performed within the prescribed time,

In FIG. 6A, the right front detection electrode 31 is turned “ON” at time t₁₀, time t₁₁ and time t₁₂. Elapsed time from the time t₁₀ the first touch operation is detected to the time t₁₂ the last touch operation is detected is within the second time T₂. The second time T₂ is preferably set within a range of not less than 1 s and not more than 3 s, and is more preferably set within a range of not less than 1 s and not more than 2 s, as an example.

Since three consecutive touch operations on the right front detection electrode 31, i.e., the first operation region 21a, are detected within the second time T₂, the control unit 6 opens or closes all the windows according to a push-down operation or a pull-up operation performed within the prescribed time. For example, when a push-down operation is performed on the operation knob 2 within the prescribed time from the time t₁₂, the control unit 6 outputs the operation information S₈ to instruct to open all the windows.

### Effects of the Second Embodiment

With the control device 1 in the second embodiment, the user can open or close all the windows by performing plural touch operations on any operation region within the second. time T₂. Therefore, operability is improved as compared to when opening while touching all operation regions.

### Third Embodiment

The third embodiment is different from the other embodiments in that all windows are opened or closed by a long press operation performed in any operation region.

FIG. 6B is an explanatory diagram illustrating a long press operation performed for a duration longer than a third time.

The predetermined operation of the third embodiment is a long press operation performed on any operation region for not less than a predetermined third time T₃. When the long press operation for not less than the predetermined third time T₃ is detected, the control unit 6 controls the power window device 7 to drive all the windows according to a push-down operation or a pull-up operation performed on the operation knob 2.

The long press operation is an operation to touch and hold the operation finger on the operation region, In FIG. 6B, the right front detection electrode 31 is turned “ON” at time t₂₀ and turned “OFF” at time t₂₁. That is, the user keeps touching the first operation region 21a from the time t₂₀ to the time t₂₁.

The condition information 50 in the third embodiment includes information about the long press operation for not less than the third time T₃. When it is determined, based on this condition information 50, that the duration of touch is not less than the third time T₃ and a push-down operation or a pull-up operation is performed within the prescribed time, the control unit 6 opens or closes all the windows. The third time T₃ is preferably set within a range of not less than 0.5 s and not more than 2 s, and is more preferably set within a range of not less than 1 s and not more than 2 s, as an example.

Since a long press operation on the right front detection electrode 31, i.e., the first operation region 21a, for more than the third time T₃ is detected, the control unit 6 opens or closes all the windows according to a push-down operation or a pull-up operation performed within the prescribed time. Fax example, when a push-down operation is performed on the operation knob 2 within the prescribed time from the time t₂₁, the control unit 6 outputs the operation information S₈ to instruct to open all the windows.

### Effects of the Third Embodiment

With the control device 1 in the third embodiment, all the windows can be opened or closed by a simple operation such as a long press operation on any operation region for more than the third time T₃.

### Fourth Embodiment

The fourth embodiment is different from the other embodiments in that a window to be driven is fully opened or fully closed when the predetermined operation is detected.

When the predetermined operation is performed, the control unit 6 in the fourth embodiment controls the power window device 7 to fully open or fully close the window to be driven, according to a push-down operation or a pull-up operation performed on the operation knob 2.

For example, in case that the predetermined operation consists of two consecutive touch operations and when two consecutive touch operations are detected within the second time T₂ while a touch operation is performed in another operation region within the first time T₁, the control unit 6 determines that the window corresponding to the operation region which satisfies the condition is to be driven. Then, when a push-down operation or a pull-up operation is performed within the prescribed time, the control unit 6 fully opens or fully closes the window to be driven.

In particular, when two touch operations are performed on, e.g., the first operation region 21a within the second time T₂, the control unit 6 determines that it is the window to be driven, based on the condition information 50. Then, when, e.g., two touch operations, one of which is started within the first time T₁, are performed on the second operation region 21b within the second time T₂, the control unit 6 determines that windows corresponding to the first operation region 21a and the second operation region 21b are to be driven, based on the condition information 50. Then, when a push-down operation or a pull-up operation is performed within the prescribed time, the control unit 6 outputs the operation information S₈ to drive the windows confirmed to be driven.

### Effects of the Fourth Embodiment

With the control device 1 in the fourth embodiment, a window(s) to be driven can be fully opened or fully closed by a simple operation.

In another embodiment, when touch operations are simultaneously performed as the predetermined operation on two operation regions for the front seats or the rear seats and a push-down operation or a pull-up operation is further performed within the prescribed time, the control device 1 drives plural windows corresponding to the operation regions which are simultaneously touch-operated.

In still another embodiment, when two operation regions for the front seats are simultaneously touch-operated and two operation regions for the rear seats are further simultaneously touch-operated within a predetermined time, the control device 1 drives all the windows according to a push-down operation or a pull-up operation performed within the prescribed time.

In still another embodiment, the control device 1 has the control unit 6 that is configured, based on a predetermined operation performed on at least one operation region among operation regions set on one operation knob 2 so as to correspond to plural windows of the vehicle 8 and also based on a push-down operation or a pull-up operation performed on the operation knob 2, to determine plural windows to be opened or closed and control the power window device 7 to drive the plural determined windows.

In still another embodiment, the control device 1 determines that windows corresponding to plural operation regions, in which a tracing operation as the predetermined operation is performed, are windows which are driven. For example, the user uses plural operation fingers and simultaneously traces operation regions corresponding to the windows intended to be driven, and then performs a push-down operation or a pull-up operation within prescribed time, thereby opening or closing plural windows.

In yet another embodiment, the control device 1 has a setting in which there is an operation to cancel the selected window. This operation is an operation different from the predetermined operation and consists of plural touch operations or a long press operation. After windows which are driven are selected by the predetermined operation, the user can cancel the selection by performing a cancel operation on the operation region corresponding to the window to be cancelled.

The control device 1 in at least one of embodiments described above is excellent in operability,

Although some embodiments and modifications of the invention have been described, these embodiments and modifications are merely an example and the invention according to claims is not to be limited thereto. These new embodiments and modifications thereof may be implemented in various other forms, and various omissions, substitutions and changes, etc., can be made without departing from the gist of the invention. In addition, not all combinations of the features described in these embodiments and modifications are necessary to solve the problem of the invention. Further, these embodiments and modifications thereof are included within the scope and gist of the invention and also within the invention described in the claims and the range of equivalency.

### REFERENCE SIGNS LIST

1 CONTROL DEVICE
2 OPERATION KNOB
3 CONTACT DETECTION UNIT
4 OPERATION DETECTION UNIT
6 CONTROL UNIT
7 POWER WINDOW DEVICE
8 VEHICLE
21a FIRST OPERATION REGION
21b SECOND OPERATION REGION
23a THIRD OPERATION REGION
23b FOURTH OPERATION REGION
31 RIGHT FRONT DETECTION ELECTRODE
32 LEFT FRONT DETECTION ELECTRODE
33 RIGHT REAR DETECTION ELECTRODE
34 LEFT REAR DETECTION ELECTRODE
81a-84a WINDOW

1. A control device, comprising a control unit that is configured, based on a predetermined operation performed on at least one operation region among operation regions set on one operation knob so as to correspond to a plurality of windows of a vehicle and also based on a push-down operation or a pull-up operation performed on the operation knob, to determine a plurality of windows to be opened or closed and control a power window device to drive the plurality of determined windows.

2. A control device, comprising:
one operation knob which comprises operation regions set so as to correspond to a plurality of windows of a vehicle and on which a push-down operation and a pull-up operation can be performed;
a contact detection unit to detect contact of a user with a plurality of operation regions;
an operation detection unit to detect the push-down operation and the pull-up operation performed on the operation knob; and
a control unit that is configured, based on a predetermined operation performed on at least one of the plurality of operation regions and also based on the push-down operation or the pull-up operation performed on the operation knob, to determine a plurality of windows to be opened or closed and control a power window device to drive the plurality of determined windows.

3. The control device according to claim 1, wherein the predetermined operation comprises touch operations respectively performed on a plurality of operation regions within a predetermined first time, and wherein the control unit controls the power window device to drive windows corresponding to the plurality of operation regions in which the touch operation is detected.

4. The control device according to claim 3, wherein the control unit measures elapsed time since time of detection of the touch operation, and confirms windows to be driven that correspond to the touch operations performed on the plurality of operation regions when the elapsed time between touch operations is within the predetermined first time.

5. The control device according to claim 4, wherein the control unit resets the windows confirmed to be driven when the push-down operation or the pull-up operation is not detected before the elapsed time since the last touch operation exceeds a predetermined prescribed time.

6. The control device according to claim 1, wherein the predetermined operation comprises a plurality of touch operations performed on any operation region within a predetermined second time, and wherein the control unit controls the power window device to drive all windows according to the push-down operation or the pull-up operations performed on the operation knob when the plurality of touch operations are detected in the any operation region.

7. The control device according to claim 1, wherein the predetermined operation comprises a long press operation performed on any operation region for not less than a predetermined third time, and wherein the control unit controls the power window device to drive all windows according to the push-down operation or the pull-up operation performed on the operation knob when the long press operation for not less than the predetermined third time is detected.

8. The control device according to claim 1, wherein when the predetermined operation is performed, the control unit controls the power window device to fully open or fully close windows to be driven, according to the push-down operation or the pull-up operation performed on the operation knob.

9. The control device according to claim 2, wherein the contact detection unit comprises an electrostatic capacitance touch sensor.

10. The control device according to claim 2, wherein the contact detection unit comprises a pressure sensor.
